(19) United States
(12) Patent Application Publication
(10) Pub. No.: US 2021/0227339 A1
(43) Pub. Date: Jul. 22, 2021

(54) Hearing Aid with Bluetooth Control

(71) Applicant: Innovation Sound Technology Co., Ltd., Shenzhen (CN)

(72) Inventors: Shun Ming Yuen, Shenzhen (CN); Wai Yin Mung, Shenzhen (CN); Ka Ming Wu, Shenzhen (CN)

(21) Appl. No.: 17/223,048

(22) Filed: Apr. 6, 2021

Related U.S. Application Data
(63) Continuation of application No. PCT/CN2019/084075, filed on Apr. 24, 2019.

(30) Foreign Application Priority Data
Mar. 6, 2019 (CN) 201920280672.0

(51) Int. Cl. H04R 25/00

(52) U.S. Cl. CPC H04R 25/554; H04R 25/609; H04R 2225/51; H04R 25/602; H04R 25/604

(57) ABSTRACT

The application belongs to the technical field of hearing aids, and discloses a type of hearing aid with Bluetooth control. There are keys connected to the micro-control unit so that when a signal is generated for the micro-control unit, the micro-control unit connects the signal to a phone via an antenna on the upper part of the Bluetooth module. With low energy technology employed, the power consumption of the Bluetooth module is relatively low. The hearing aid itself can also be adjusted for different audio through Bluetooth, so that different users can make adjustments according to their needs.

### CROSS REFERENCE TO RELATED APPLICATIONS

The present application is a Continuation Application of PCT Application No. PCT/CN2019/084075 filed on Apr. 24, 2019, which claims the benefit of Chinese Patent Application No. 201920280672.0 filed on Mar. 6, 2019. All the above are hereby incorporated by reference.

### FIELD OF THE INVENTION

The application specifically relates to a hearing aid with Bluetooth control, belonging to the technical field of hearing aids.

### BACKGROUND OF THE INVENTION

A Safety Clock provides 24-hour assistance and care services for the elderly or those in need. The assistance and care service center of the service provider will provide assistance in response to the needs of the caller, and will call an ambulance or report to the police in an emergency. In addition, the assistance center also has information on other social resources to facilitate assistance for users. Sometimes the Safety Clock breaks down due to long-term non-use. There are also some other types of portable safety clocks on the market, but either the above-mentioned problem may arise, or the user forgets to carry along, or cannot find when assistance is needed.

### CONTENT OF THE APPLICATION

The technical problem to be solved by the application is to overcome the existing defects and to provide a hearing aid with Bluetooth control. There are keys connected to the micro-control unit so that when a signal is generated for the micro-control unit, the micro-control unit connects the signal to the phone via an antenna on the upper part of the Bluetooth module. With low energy technology employed, the power consumption of the Bluetooth module is relatively low. The hearing aid itself can also be adjusted for different audio through Bluetooth, so that different users can make adjustments according to their needs. The application can effectively solve the problems in the background of the invention.

In order to solve the above technical problems, the present application provides the following technical solutions:

The application provides a type of hearing aids with Bluetooth control, which consists of:

A rubber hub for the hearing aid, inside which a main board is fixed. One side of the main board is attached with a circuit board, a speaker and a battery in order from top to bottom;

An in-ear rubber hub secured on one side of the speaker. On the outside of the circuit board is fixed with a rubber earplug. A microphone and keys fixed on the other side of the main board sequentially from top to bottom;

A micro-control unit, a D/A converter, an amplifier and a Bluetooth module fixed on the upper part of the main board. The keys are connected to the micro-control unit so that when a signal is generated for the micro-control unit, the micro-control unit connects the signal to the phone via an antenna on the upper part of the Bluetooth module.

As a preferred technical solution of the application, the microphone is used for collecting external sound and transmitting the sound to the micro-control unit. The digital signals at the output end of the micro-control unit are converted into analog signals by the D/A converter, and the input signals are amplified in voltage or power by the amplifier before being transmitted to the speaker.

As a preferred technical solution of the application, the battery is electrically connected to the main board.

As a preferred technical solution of the application, the micro-control unit is electrically connected to the circuit board.

Beneficial effects achieved by the application: The keys are connected to the micro-control unit so that when a signal is generated for the micro-control unit, the micro-control unit connects the signal to the phone via an antenna on the upper part of the Bluetooth module. With low energy technology employed, the power consumption of the Bluetooth module is relatively low. The hearing aid itself can also be adjusted for different audio through Bluetooth, so that different users can make adjustments according to their needs.

### BRIEF INTRODUCTION OF THE DRAWINGS

The accompanying drawings are used to provide a further understanding of the application and constitute a part of the Specification. Together with the embodiments of the application, they are intended to interpret the application but do not constitute a limitation to the application.

In the accompanying drawings:

FIG. 1 is a schematic diagram for the overall structure of a hearing aid with Bluetooth control according to embodiments of the application;

FIG. 2 is a circuit diagram of a hearing aid with Bluetooth control according to embodiments of the application;

Numbers in the drawings: 1. Rubber hub to the hearing aid; 2. Circuit board; 3. Speaker; 4. In-ear rubber hub; 5. Rubber earplugs; 6. Battery; 7. Keys; 8. Microphone; 9. Main board; 10. Micro-control unit; 11. D/A converter; 12. Amplifier; 13. Bluetooth module.

### DETAILED DESCRIPTION OF THE PREFERRED EMBODIMENTS

The preferred embodiments of the application are described below in conjunction with the drawings. It shall be understood that the preferred embodiments described herein are only used to illustrate and interpret the present application, rather than to limit the present application.

### Embodiments

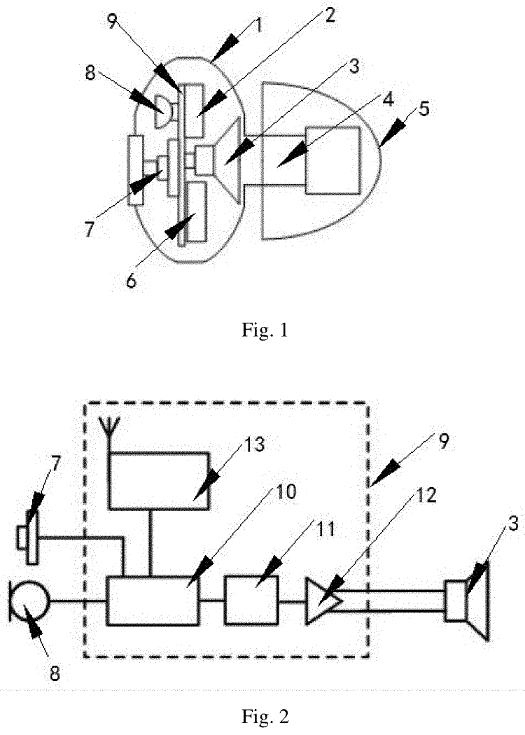

Please refer to FIG. 1-2. The application relates to a hearing aid with Bluetooth control, comprising:

A rubber hub (1) for the hearing aid, inside which a main board (9) is fixed. One side of the main board (9) is attached with a circuit board (2), a speaker (3) and a battery (6) in order from top to bottom;

An in-ear rubber hub (4) secured on one side of the speaker (3), on the outside of which is fixed with a rubber earplug (5). A microphone (8) and keys (7) are fixed on the other side of the main board (9) sequentially from top to bottom;

A micro-control unit (10), a D/A converter (11), an amplifier (12) and a Bluetooth module (13) fixed on the upper part of the main board (9). The keys (7) are connected to the micro-control unit (10) so that when a signal is generated for the micro-control unit (10), the micro-control unit (10) connects the signal to the phone via antenna on the upper part of the Bluetooth module (13). The microphone (8) is used for collecting external sound and transmitting the sound to the micro-control unit (10). The digital signals at the output end of the micro-control unit (10) are converted into analog signals by the D/A converter (11), and the input signals are amplified in voltage or power by the amplifier (12) before being transmitted to the speaker (3). The battery (6) is electrically connected to the main board (9) to ensure the normal operation of the hearing aid circuit. When power is insufficient, the battery (6) can be replaced, and the micro-control unit (10) is electrically connected to the circuit board (2).

When operated, the keys connected to the micro-control unit are pressed so that when a signal is generated for the micro-control unit, the micro-control unit connects the signal to the phone via an antenna on the upper part of the Bluetooth module. With low energy technology employed, the power consumption of the Bluetooth module is relatively low. The hearing aid itself can also be adjusted for different audio through Bluetooth, so that different users can make adjustments according to their needs. If the hearing aid is out of power or not connected to the phone, the digital signals at the output end of the micro-control unit (10) are converted into analog signals by the D/A converter (11), and the input signals are amplified in voltage or power by the amplifier (12) before being transmitted to the speaker (3) as a reminder. Therefore, when the hearing aid is out of power, the Safety Clock is also out of power. A broken hearing aid means that the Safety Clock is also broken.

Last thing to note: The above descriptions are only preferred embodiments of the present invention, and are not used to limit the application. Although the application has been described in detail with reference to the foregoing embodiments, those skilled in the art may still modify the technical solutions described in the foregoing embodiments, or equivalently replace some of the technical features. Any modification, equivalent replacement, improvement, etc. made within the spirit and principle of the application shall be included in the protection scope of the application.

What is claimed is:

1. A hearing aid with Bluetooth control, wherein it comprises:
a rubber hub (1) for the hearing aid, inside which a main board (9) is fixed, one side of the main board (9) are attached with a circuit board (2), a speaker (3) and a battery (6) in order from top to bottom;
an in-ear rubber hub (4) secured on one side of the speaker (3), on the outside of which is fixed with a rubber earplug (5);
a microphone (8) and keys (7) fixed on the other side of the main board (9) sequentially from top to bottom;
a micro-control unit (10), a D/A converter (11), an amplifier (12) and a Bluetooth module (13) are fixed on the upper part of the main board (9), the keys (7) are connected to the micro-control unit (10) so that when a signal is generated for the micro-control unit (10), the micro-control unit (10) connects the signal to the phone via an antenna on the upper part of the Bluetooth module (13).

2. A hearing aid with Bluetooth control according to claim 1, wherein the microphone (8) is used for collecting external sound and transmitting the sound to the micro-control unit (10), the digital signals at the output end of the micro-control unit (10) are converted into analog signals by the D/A converter (11), and the input signals are amplified in voltage or power by the amplifier (12) before being transmitted to the speaker (3).

3. A hearing aid with Bluetooth control according to claim 1, wherein the battery (6) is electrically connected to the main board (9).

4. A hearing aid with Bluetooth control according to claim 1, wherein the micro-control unit (10) is electrically connected to the circuit board (2).
